(19) United States
(12) Patent Application Publication
(10) Pub. No.: US 2013/0163067 A1
(43) Pub. Date: Jun. 27, 2013

(54) COLOR ELECTRONIC PAPER DISPLAYS USING BLACK MATRICES AND METHODS OF FABRICATING THE SAME

(71) Applicants: Chul Am KIM, Daejeon (KR); Jiyoung Oh, Daejeon (KR)

(72) Inventors: Chul Am KIM, Daejeon (KR); Jiyoung Oh, Daejeon (KR)

(73) Assignee: ELECTRONICS AND TELECOMMUNICATIONS RESEARCH INSTITUTE, Daejeon (KR)

(21) Appl. No.: 13/606,167

(22) Filed: Sep. 7, 2012

(30) Foreign Application Priority Data
Dec. 22, 2011 (KR) 10-2011-0140140

(51) Int. Cl. G02B 26/00; B05D 5/06

(52) U.S. Cl. 359/296; 427/66

(57) ABSTRACT

Color electronic paper displays are provided. The color electronic paper display includes a substrate, a plurality of black matrices arrayed with a certain distance therebetween on the substrate, and electronic ink microcapsules between the black matrices. The black matrices cover interconnection lines disposed on the substrate. The electronic ink microcapsules include at least one first microcapsule containing white particles and yellow particles, at least one second microcapsule containing white particles and magenta particles, and at least one third microcapsule containing white particles and cyan particles. Related methods are also provided.

### CROSS-REFERENCE TO RELATED APPLICATIONS

This U.S. non-provisional patent application claims priority under 35 U.S.C. §119 to Korean Patent Application No. 10-2011-0140140, filed on Dec. 22, 2011, the disclosure of which is hereby incorporated by reference in its entirety.

### BACKGROUND

1. Technical Field

The present disclosure herein relates to color electronic paper displays and methods of fabricating the same and, more particularly, to color electronic paper displays using black matrices and methods of fabricating the same.

2. Description of Related Art

Electronic papers may be thin and flexible like wooden papers. Further, the electronic papers may have some advantages of excellent visibility and low power consumption. Thus, the electronic papers may be compatible with the wooden papers and may be very attractive as next generation displays. Moreover, the electronic papers may have a bi-stability that can retain their stored images even when their power supplies are interrupted. Accordingly, the power consumption of the electronic papers may be minimized.

Microcapsule type electrophoretic displays among diverse techniques for realizing the electronic papers have been commercialized to be utilized as one of major products. The microcapsule type electrophoretic displays may exhibit images using a phenomenon that charged particles in solutions are moved up and down by electrophoresis when an electric field is applied to the solutions having colors contrasted with each other.

Recently, color electronic papers have been realized by fabricating direct pixels without color filters to improve the color reproducibility of the electronic papers. In such a case, if a plurality of sub-pixels are successively arrayed to realize a specific color, it may be difficult to realize a deep color because the sub-pixels constituting a single pixel have arbitrary colors even though the specific color is revealed.

### SUMMARY

Exemplary embodiments are directed to color electronic paper displays and methods of fabricating the same.

According to some embodiments, a method of fabricating a color electronic paper display includes forming electronic ink microcapsules, forming black matrices on a substrate, and supplying the electronic ink microcapsules into spaces between the black matrices to form sub-pixels. The electronic ink microcapsules include at least one first microcapsule containing white particles and yellow particles, at least one second microcapsule containing white particles and magenta particles, and at least one third microcapsule containing white particles and cyan particles.

In some embodiments, forming the electronic ink microcapsules may include forming an electrophoretic electronic ink suspension by dispersing pigment particles in dielectric oil or a liquid crystal type electronic ink suspension by dispersing pigment particles in anisotropic liquid crystal oil, emulsifying the electrophoretic electronic ink suspension or the liquid crystal type electronic ink suspension in an aqueous solution to form emulsion, and coating the emulsion with a polymer material to form electronic ink microcapsules.

In some embodiments, a distance between the black matrices may be within the range of about 100 micrometers to about 150 micrometers.

In some embodiments, the black matrices may be formed using a photo mask.

In some embodiments, the black matrices may be formed of a black matrix layer containing black dyes.

In some embodiments, the black matrices may be formed to cover interconnection lines connected to thin film transistors disposed in the substrate.

In some embodiments, the electronic ink microcapsules may further include at least one fourth microcapsule containing white particles and black particles. Each of the white particles, the yellow particles, the magenta particles, the cyan particles and the black particles may have a positive charge or a negative charge.

According to further embodiments, a color electronic paper display includes a substrate, a plurality of black matrices arrayed with a certain distance therebetween on the substrate, and electronic ink microcapsules between the black matrices. The black matrices cover interconnection lines disposed on the substrate. The electronic ink microcapsules include at least one first microcapsule containing white particles and yellow particles, at least one second microcapsule containing white particles and magenta particles, and at least one third microcapsule containing white particles and cyan particles.

In some embodiments, the substrate may be a transparent substrate including indium tin oxide (ITO), indium zinc oxide, tin oxide (SnO₂) or zinc oxide (ZnO).

In some embodiments, the substrate may include thin film transistors.

In some embodiments, the certain distance between the black matrices may be within the range of about 100 micrometers to about 150 micrometers.

In some embodiments, the black matrices may include a black matrix layer containing black dyes.

In some embodiments, the electronic ink microcapsules may further include at least one fourth microcapsule containing white particles and black particles. Each of the white particles, the yellow particles, the magenta particles, the cyan particles and the black particles may have a positive charge or a negative charge.

### BRIEF DESCRIPTION OF THE DRAWINGS

Embodiments of the inventive concept will become more apparent in view of the attached drawings and accompanying detailed description.

FIG. 1 is a front view illustrating a color electronic paper display according to some exemplary embodiments.

FIG. 2 is a front view illustrating a color electronic paper display according to some exemplary embodiments.

FIG. 3 is a process flowchart illustrating methods of fabricating a color electronic paper display according to some exemplary embodiments.

FIGS. 4A, 4B, 4C and 4D are cross sectional views taken along a line I-I′ of FIG. 1 to illustrate methods of fabricating a color electronic paper display according to some exemplary embodiments.

FIG. 5 is a cross sectional view taken along a line J-J′ of FIG. 2 to illustrate a color electronic paper display according to some exemplary embodiments.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Rather, these exemplary embodiments are provided so that this disclosure will be thorough and complete, and will fully convey the scope of the invention to those skilled in the art. The same reference numerals or the same reference designators denote the same elements throughout the specification.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that the terms “has”, “having”, “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be further understood that when an element such as a layer, region or substrate is referred to as being “on” another element, it can be directly on the other element or intervening elements may be present. In contrast, the term “directly” means that there are no intervening elements. Similarly, it will be also understood that when an element is referred to as being “connected” or “coupled” to another element, it may be directly connected or coupled to the other element or intervening elements may be present.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. For example, a region illustrated as a rectangle may have rounded or curved features. Thus, areas exemplified in the drawings have general properties, and are used to illustrate specific shapes of elements. Accordingly, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the inventive concepts. Exemplary embodiments of aspects of the present inventive concept explained and illustrated herein include their complementary counterparts.

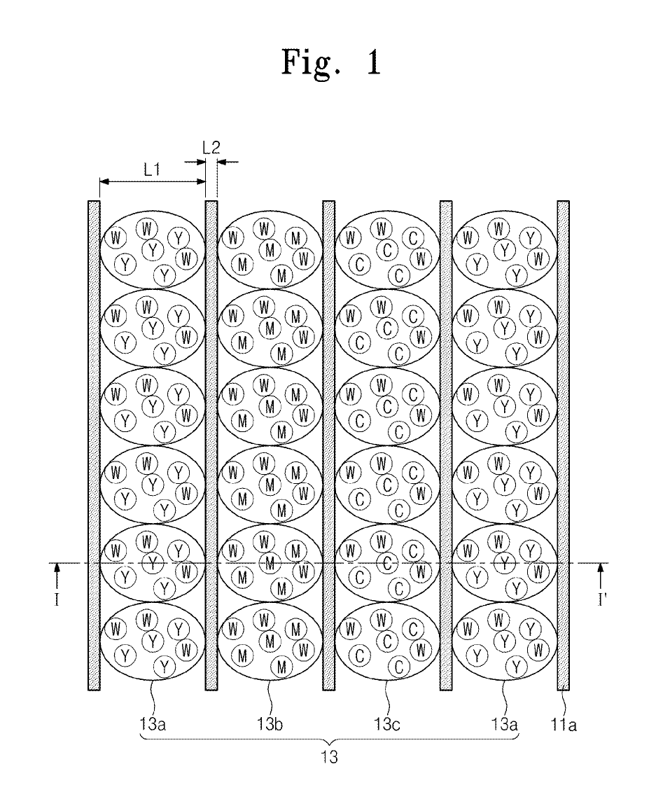

FIG. 1 is a front view illustrating a color electronic paper display according to some exemplary embodiments.

Referring to FIG. 1, a plurality of black matrices 11a may be successively arrayed with a certain distance therebetween, and spaces between the black matrices 11a may be filled with a microcapsule 13. The microcapsule 13 may include first microcapsules 13a, second microcapsules 13b and third microcapsules 13c. Each of the first microcapsules 13a may contain white particles W and yellow particles Y, each of the second microcapsules 13b may contain white particles W and magenta particles M, and each of the third microcapsules 13c may contain white particles W and cyan particles C. Each of the white particles W, the yellow particles Y, the magenta particles M and the cyan particles C may have a positive charge or a negative charge. The white particles W, the yellow particles Y, the magenta particles M and the cyan particles C may be irregularly distributed in the first to third microcapsules 13a, 13b and 13c. The first microcapsules 13a in one of the spaces between the black matrices 11a may constitute a single sub-pixel. The second microcapsules 13b in one of the spaces between the black matrices 11a may also constitute a single sub-pixel. Similarly, the third microcapsules 13c in one of the spaces between the black matrices 11a may constitute a single sub-pixel. That is, each of the regions between the black matrices 11a may correspond to a single sub-pixel, and three adjacent sub-pixels including the first to third microcapsules 13a, 13b and 13c may constitute a single pixel.

Each of the sub-pixels may have a width L1 of about 100 micrometers to about 150 micrometers. When the width L1 of the sub-pixels is within the range of about 100 micrometers to about 150 micrometers, a yellow color, a magenta color and a cyan color may be mixed in a single pixel. A width L2 of each of the black matrices 11a may correspond to a distance between the adjacent sub-pixels. The black matrices 11a may improve a light absorptivity when the colors of the yellow particles Y, the magenta particles M and the cyan particles C are mixed, thereby revealing a strong black color. As a result, a color reproducibility of the color electronic paper display may be enhanced. Further, each of the first to third microcapsules 13a, 13b and 13c may include the white particles W. Thus, a vivid white color may be realized.

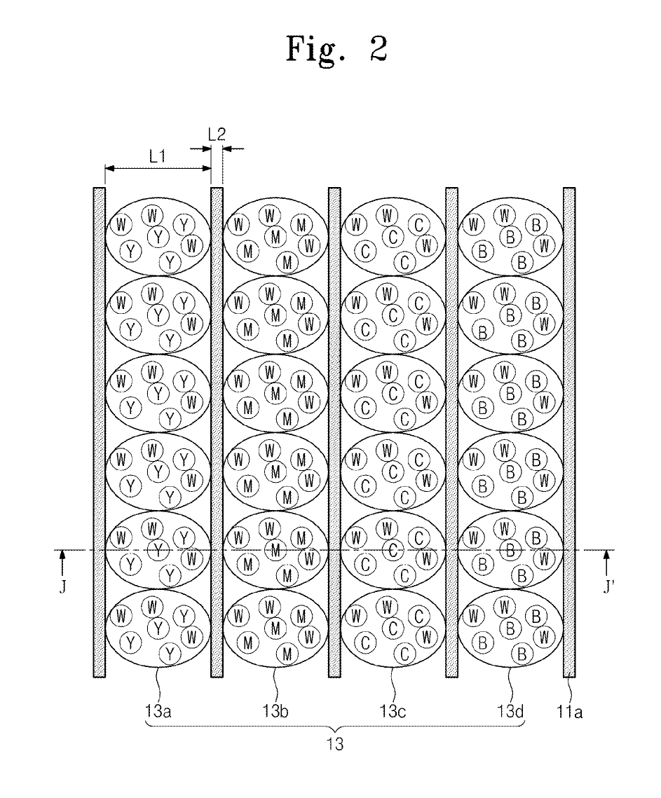

FIG. 2 is a front view illustrating a color electronic paper display according to some exemplary embodiments. To avoid duplicate explanations, descriptions to the same elements as set forth in the previous exemplary embodiment may be omitted or briefly mentioned in this exemplary embodiment.

Referring to FIG. 2, a plurality of black matrices 11a may be successively arrayed with a certain distance therebetween, and spaces between the black matrices 11a may be filled with a microcapsule 13. The microcapsule 13 may include first microcapsules 13a, second microcapsules 13b, third microcapsules 13c and fourth microcapsules 13d. Each of the first microcapsules 13a may contain white particles W and yellow particles Y, each of the second microcapsules 13b may contain white particles W and magenta particles M, each of the third microcapsules 13c may contain white particles W and cyan particles C, and each of the fourth microcapsules 13d may contain white particles W and black particles B. Each of the white particles W, the yellow particles Y, the magenta particles M, the cyan particles C and the black particles B may have a positive charge or a negative charge. The white particles W, the yellow particles Y, the magenta particles M, the cyan particles C and the black particles B may be irregularly distributed in the first to fourth microcapsules 13a, 13b, 13c and 13d. The first microcapsules 13a in one of the spaces between the black matrices 11a may constitute a single sub-pixel, and the second microcapsules 13b in one of the spaces between the black matrices 11a may also constitute a single sub-pixel. Similarly, the third microcapsules 13c in one of the spaces between the black matrices 11a may constitute a single sub-pixel, and the fourth microcapsules 13d in one of the spaces between the black matrices 11a may also constitute a single sub-pixel. That is, each of the regions between the black matrices 11a may correspond to a single sub-pixel, and four adjacent sub-pixels including the first to fourth microcapsules 13a, 13b, 13c and 13d may constitute a single pixel.

Each of the sub-pixels may have a width L1 of about 100 micrometers to about 150 micrometers. When the width L1 of the sub-pixels is within the range of about 100 micrometers to about 150 micrometers, a yellow color, a magenta color, a cyan color and a black color may be mixed in a single pixel. A width L2 of each of the black matrices 11a may correspond to a distance between the adjacent sub-pixels. The black matrices 11a may improve a light absorptivity when the colors of the yellow particles Y, the magenta particles M, the cyan particles C and the black particles B are mixed, thereby revealing a strong black color. As a result, a color reproducibility of the color electronic paper display may be enhanced. Further, each of the first to fourth microcapsules 13a, 13b, 13c and 13d may include the white particles W. Thus, a vivid white color may be realized.

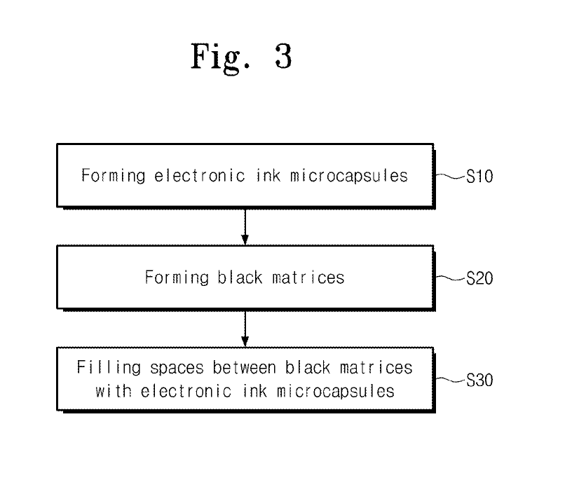

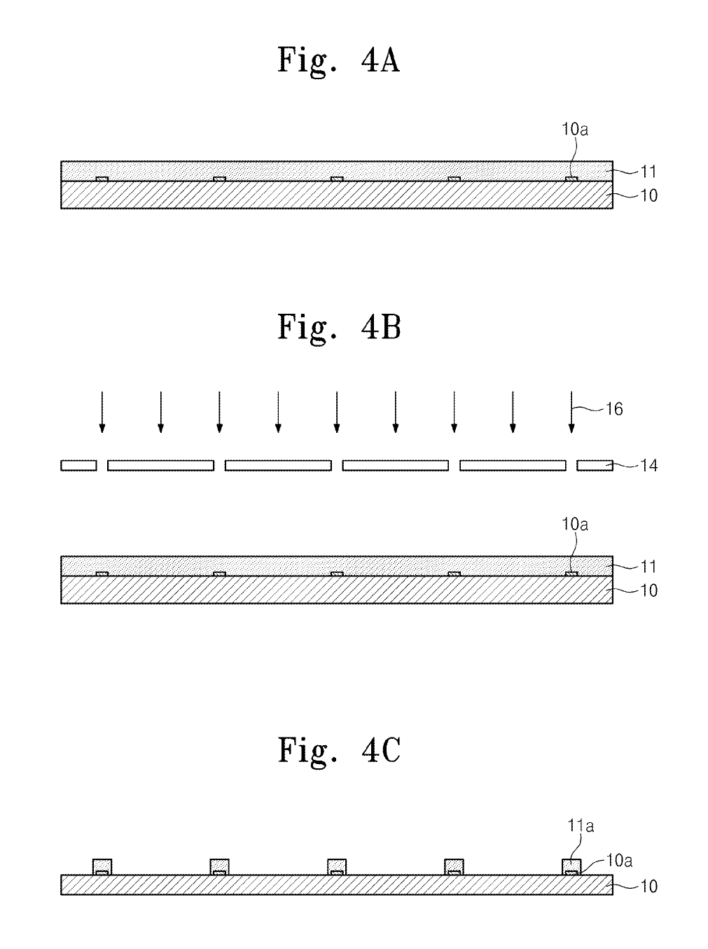

FIG. 3 is a process flowchart illustrating methods of fabricating a color electronic paper display according to some exemplary embodiments. FIGS. 4A, 4B, 4C and 4D are cross sectional views taken along a line I-I′ of FIG. 1 to illustrate methods of fabricating a color electronic paper display according to some exemplary embodiments.

Referring to FIG. 3, electronic ink microcapsules may be fabricated (S10). A liquid crystal type electronic ink suspension or an electrophoretic electronic ink suspension may be fabricated. The liquid crystal type electronic ink suspension may be fabricated by dispersing pigment particles in anisotropic liquid crystal oil, and the electrophoretic electronic ink suspension may be fabricated by dispersing pigment particles in dielectric oil. The pigment particles may include at least one species of inorganic pigment particles, organic pigment particles and combination thereof. For example, the pigment particles may include at least one of titanium oxide (TiO₂), calcium carbonate (CaCO₃), talc, black iron oxide, cadmium red, cadmium yellow, molybdenum red, cobalt green, cobalt blue, cobalt violet and manganese violet. The organic pigment particles may be cross linked polymer particles. The organic pigment particles may include at least one species of azo type pigment, cyanine type pigment including copper phtalocyanine pigment, and anthraquinone type pigment. The pigment particles may be dispersed in the dielectric oil or the anisotropic liquid crystal oil using an ultrasonic processor system.

The electronic ink suspension may be emulsified in an aqueous solution to form emulsion. The electronic ink microcapsules may be fabricated using a coaservation process or an in-situ process. A type of the aqueous solution may be determined according to the fabrication process of the electronic ink microcapsules. When the electronic ink microcapsules are fabricated using a coaservation process, the aqueous solution may include at least one selected from the group consisting of gelatin, acacia gum, carrageenan, carboxymethyl cellulose, hydrolyzed styrene anhydride copolymer, casein, albumin, methyl vinyl ether co-maleic acid anhydride and cellulose phthalate. Alternatively, when the electronic ink microcapsules are fabricated using an in-situ process, the aqueous solution may include melamine or urea. The electronic ink suspension may be slowly poured into the aqueous solution and may be agitated in the aqueous solution, thereby forming the emulsion.

Polymer material may surround the emulsion to fabricate the electronic ink microcapsules. The polymer material may be formed by adding a cross linking agent or a hardening agent into the emulsion. The cross linking agent or the hardening agent may include an aldehyde type material such as formaldehyde or glutaric aldehyde. The polymer material may be a natural polymer material such as gelatin, arabian gum or sodium alginate. The polymer material may be a semi-synthetic polymer material or a synthetic polymer material. The semi-synthetic polymer material may include carboxyl methyl cellulose or ethyl cellulose, and the synthetic polymer material may include polyvinyl alcohol, nylon, polyurethane, polyester, epoxy or melamine-formalin.

The electronic ink microcapsules may include first to third microcapsules. Each of the first microcapsules may contain white particles and yellow particles, each of the second microcapsules may contain white particles and magenta particles, and each of the third microcapsules may contain white particles and cyan particles.

Referring to FIGS. 3, 4A, 4B and 4C, black matrix layer 11 may be formed on a substrate 10 (S20 of FIG. 3). The substrate 10 may be a transparent substrate which is formed of indium tin oxide (ITO), indium zinc oxide, tin oxide (SnO₂) or zinc oxide (ZnO). The substrate 10 may include thin film transistors and interconnection lines 10a connected to the thin film transistors. The black matrix layer 11 may be patterned to form black matrices 11a. The black matrix layer 11 may be patterned using a photo mask 14. The black matrix layer 11 may be formed of a negative photoresist layer containing black dyes. The black matrices 11a may be formed to overlap with the interconnection lines 10a. Each of the black matrices 11a may be formed to have a width L2 corresponding to a distance between sub-pixels. Further, a distance between the black matrices 11a may correspond to a width L1 of the sub-pixels, and the width L1 of the sub-pixels may be within the range of about 100 micrometers to about 150 micrometers.

The methods of the fabricating the black matrices 11a will be described in more detail hereinafter.

Referring again to FIGS. 3 and 4A, the black matrix layer 11 containing black dyes may be formed on the substrate 10. The substrate 10 may include the thin film transistors and the interconnection lines 10a connected to the thin film transistors, as described above. The black matrix layer 11 containing black dyes may be formed using a spin coating process.

Referring again to FIGS. 3 and 4B, a photo mask 14 may be disposed over the substrate 10. The photo mask 14 may be aligned with the substrate 10 such that transparent regions of the photo mask 14 overlap with the interconnection lines 10a in a plan view. Ultraviolet rays 16 may be irradiated onto the black matrix layer 11 containing the black dyes through the photo mask 14.

Referring again to FIGS. 3 and 4C, portions of the black matrix layer 11, which are not exposed by the ultraviolet rays 16, may be selectively removed to form the black matrices 11a.

Referring to FIGS. 3 and 4D, the electronic ink microcapsules 13 may fill spaces between the black matrices 11a, thereby forming the sub-pixels (S30 of FIG. 3). The electronic ink microcapsule 13 may include a first microcapsule 13a, a second microcapsule 13b and a third microcapsule 13c which are successively arrayed in respective ones of the spaces between the black matrices 11a. The electronic ink microcapsule 13 may be supplied into the spaces between the black matrices 11a using a liquid dispenser.

Each of the spaces between the black matrices 11a may correspond to a sub-pixel region, and the sub-pixels may be formed to have a width L1 of about 100 micrometers to about 150 micrometers. The width L2 of each of the black matrices 11a may correspond to a distance between the adjacent sub-pixels.

The microcapsule 13 may include the first microcapsule 13a, the second microcapsule 13b and the third microcapsule 13c, as described above. The first microcapsule 13a may contain white particles W and yellow particles Y, the second microcapsule 13b may contain white particles W and magenta particles M, and the third microcapsule 13c may contain white particles W and cyan particles C. Each of the white particle W, the yellow particle Y, the magenta particle M and the cyan particle C may have a positive charge or a negative charge. The white particles W, the yellow particles Y, the magenta particles M and the cyan particles C may be irregularly distributed in the first to third microcapsules 13a, 13b and 13c. Each of the first microcapsule 13a, the second microcapsule 13b and the third microcapsule 13c may constitute a single sub-pixel. Three adjacent sub-pixels including the first to third microcapsules 13a, 13b and 13c may constitute a single pixel.

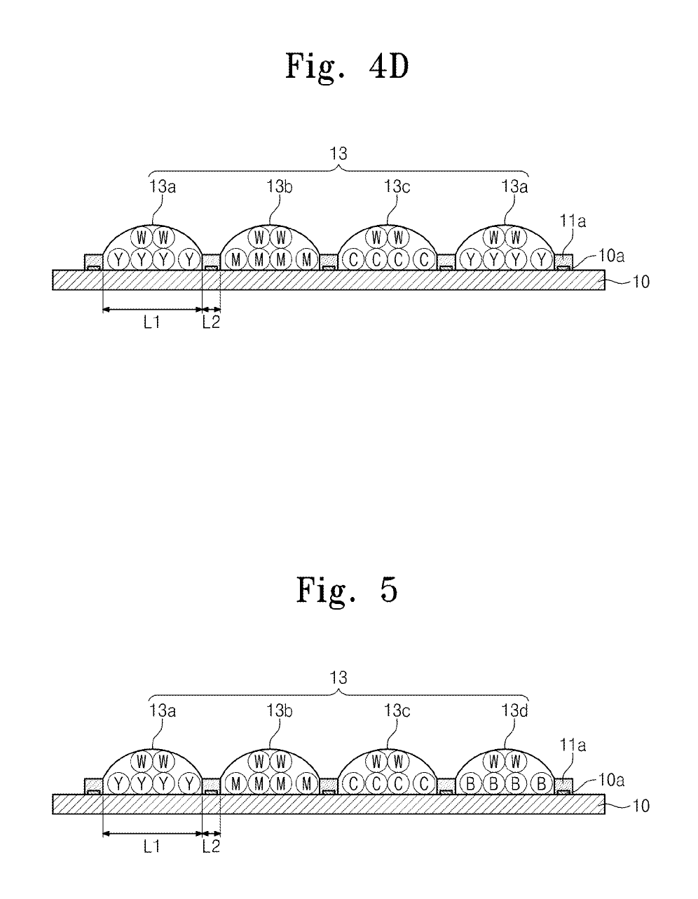

FIG. 5 is a cross sectional view taken along a line J-J′ of FIG. 2 to illustrate a color electronic paper display according to some exemplary embodiments. To avoid duplicate explanations, descriptions to the same elements as set forth in the previous exemplary embodiments may be omitted or briefly mentioned in the present exemplary embodiment.

Referring to FIGS. 3 and 5, the electronic ink microcapsule 13 may fill spaces between the black matrices 11a, thereby forming the sub-pixels (S30 of FIG. 3). The electronic ink microcapsule 13 may include a first microcapsule 13a, a second microcapsule 13b, a third microcapsule 13c and a fourth microcapsule 13d which are successively arrayed in respective ones of the spaces between the black matrices 11a. The first microcapsule 13a may contain white particles W and yellow particles Y, and the second microcapsule 13b may contain white particles W and magenta particles M. The third microcapsule 13c may contain white particles W and cyan particles C, and the fourth microcapsule 13d may contain white particles W and black particles B. Each of the white particle W, the yellow particle Y, the magenta particle M, the cyan particle C and the black particles B may have a positive charge or a negative charge. The white particles W, the yellow particles Y, the magenta particles M, the cyan particles C and the black particles B may be irregularly distributed in the first to fourth microcapsules 13a, 13b, 13c and 13d. Each of the first microcapsule 13a, the second microcapsule 13b, the third microcapsule 13c and the fourth microcapsule 13d may constitute a single sub-pixel. Four adjacent sub-pixels including the first to fourth microcapsules 13a, 13b, 13c and 13d may constitute a single pixel.

According to the exemplary embodiments set forth above, black matrices may be disposed between sub-pixels of a color electronic paper display. The black matrices may improve a light absorptivity when colors of yellow particles, magenta particles M and cyan particles C are mixed, thereby revealing a strong black color. As a result, a color reproducibility of the color electronic paper display may be enhanced.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A method of fabricating a color electronic paper display, the method comprising:
forming electronic ink microcapsules;
forming black matrices on a substrate; and
supplying the electronic ink microcapsules into spaces between the black matrices to form sub-pixels,
wherein the electronic ink microcapsules include at least one first microcapsule containing white particles and yellow particles, at least one second microcapsule containing white particles and magenta particles, and at least one third microcapsule containing white particles and cyan particles.

2. The method of claim 1, wherein forming the electronic ink microcapsules includes:
forming an electrophoretic electronic ink suspension by dispersing pigment particles in dielectric oil or a liquid crystal type electronic ink suspension by dispersing pigment particles in anisotropic liquid crystal oil;
emulsifying the electrophoretic electronic ink suspension or the liquid crystal type electronic ink suspension in an aqueous solution to form emulsion; and
coating the emulsion with a polymer material to form electronic ink microcapsules.

3. The method of claim 1, wherein a distance between the black matrices is within the range of about 100 micrometers to about 150 micrometers.

4. The method of claim 1, wherein the black matrices are formed using a photo mask.

5. The method of claim 1, wherein the black matrices are formed of a black matrix layer containing black dyes.

6. The method of claim 1, wherein the black matrices are formed to cover interconnection lines connected to thin film transistors disposed in the substrate.

7. The method of claim 1, wherein the electronic ink microcapsules further include at least one fourth microcapsule containing white particles and black particles.

8. The method of claim 7, wherein each of the white particles, the yellow particles, the magenta particles, the cyan particles and the black particles has a positive charge or a negative charge.

9. A color electronic paper display, the display comprising:
a substrate;
a plurality of black matrices arrayed with a certain distance therebetween on the substrate; and
electronic ink microcapsules between the black matrices,
wherein the black matrices cover interconnection lines disposed on the substrate; and
wherein the electronic ink microcapsules include at least one first microcapsule containing white particles and yellow particles, at least one second microcapsule containing white particles and magenta particles, and at least one third microcapsule containing white particles and cyan particles.

10. The display of claim 9, wherein the substrate is a transparent substrate including indium tin oxide (ITO), indium zinc oxide, tin oxide (SnO₂) or zinc oxide (ZnO).

11. The display of claim 9, wherein the substrate includes thin film transistors.

12. The display of claim 9, wherein the certain distance between the black matrices is within the range of about 100 micrometers to about 150 micrometers.

13. The display of claim 9, wherein the black matrices include a black matrix layer containing black dyes.

14. The display of claim 9, wherein the electronic ink microcapsules further include at least one fourth microcapsule containing white particles and black particles.

15. The display of claim 14, wherein each of the white particles, the yellow particles, the magenta particles, the cyan particles and the black particles has a positive charge or a negative charge.
